(19) United States
(12) Patent Application Publication
(10) Pub. No.: US 2013/0113927 A1
(43) Pub. Date: May 9, 2013

(54) LIGHT PROJECTOR AND VISION SYSTEM FOR DISTANCE DETERMINATION

(71) Applicants: Frederik Jan De Bruijn, Eindhoven (NL); Harold Agnes Wilhelmus Schmeitz, Eindhoven (NL)

(72) Inventors: Frederik Jan De Bruijn, Eindhoven (NL); Harold Agnes Wilhelmus Schmeitz, Eindhoven (NL)

(73) Assignee: KONINKLIJKE PHILIPS ELECTRONICS N.V., EINDHOVEN (NL)

(21) Appl. No.: 13/809,191

(22) PCT Filed: Jul. 12, 2011
(86) PCT No.: PCT/IB2011/053098

§ 371 Date: Jan. 9, 2013

(30) Foreign Application Priority Data
Jul. 16, 2010 (EP) 10169800.9

(51) Int. Cl. F21V 5/00; H04N 7/18

(52) U.S. Cl. CPC F21V 5/004; H04N 7/18
USPC 348/136; 362/311.01; 362/235; 250/495.1

(57) ABSTRACT

A light projector comprises a stack of layered planar optical elements where the stack comprises a group (103) of planar optical elements (107-111) arranged to provide a plurality of light patterns. The stack may specifically comprise a group of transparent layers having opaque patterns such that light propagating through the layers results in the light patterns. The light patterns reach a microlens array (101) which is arranged to focus the light patterns at different focal distances. In some scenarios, programmable optical elements may be used to generate the light patterns. A vision system may determine characteristics of objects based on reflections of the projected light patterns. The approach may in particular provide an efficient yet low cost light projection system for distance determination.

### FIELD OF THE INVENTION

The invention relates to a light projector and associated vision system and in particular, but not exclusively, to approaches for detecting characteristics of objects from reflections of projected light.

### BACKGROUND OF THE INVENTION

The advent and increasing practicality of complex signal processing and increasingly controllable optical elements have led to optical and vision systems becoming more and more complex and providing more and more advanced functionality. Indeed, optical systems or vision systems are increasingly used to provide automated or assisted functionality such as object detection, distance determination etc.

As an example, U.S. Pat. No. 7,012,750 discloses a system wherein an optical pattern is projected on an object and used to focus a camera. The system includes a focus detection means which adjusts the focussing of the camera until the pattern is in focus. The disclosed system generates the optical pattern by sending coherent laser light through a microlens array. The diffraction of the microlens array causes the coherent laser light to generate an interference pattern with peaks caused by constructive interference and troughs caused by destructive interference. U.S. Pat. No. 7,012,750 discloses the use of a non-isotropic array lens to provide a line interference pattern which is projected on the object to assist the autofocussing.

As another example, it has been proposed to project different patterns at different focal distances such that objects at different distances may reflect different patterns. However, such multi-focal systems tend to be relatively complex, inflexible, costly and suboptimal.

Furthermore, although increasingly advanced and complex applications of optical patterns have been proposed, these tend to be limited to specific applications or to perform suboptimally.

Thus, improved or enhanced systems would be advantageous including approaches providing additional functionality, applications, flexibility, facilitated implementation, reduced cost and/or which provide improved performance relative to current approaches.

### SUMMARY OF THE INVENTION

Accordingly, the Invention seeks to preferably mitigate, alleviate or eliminate one or more of the above mentioned disadvantages singly or in any combination.

According to an aspect of the invention there is provided a light projector comprising an arrangement of layered optical elements, the stack comprising: a group of at least one optical element arranged to provide a plurality of light patterns; and a micro lens array arranged to focus the plurality of light patterns at different focal distances.

The invention may provide a light projector with additional functionality suitable for many different applications. The invention may in particular provide a low complexity and/or low cost means of generating multifocal optical patterns that can reflect of objects. Various characteristics of objects may be determined from the pattern of projections on the objects. The use of a microlens array together with the plurality of optical light patterns provides a particularly efficient implementation. The light projector may provide a particular efficient generation of optical patterns focused at different distances from the light projector.

The micro lens may specifically be arranged to focus the light patterns at different distances as a result of refraction of the light falling on each microlens. The microlens array may in many scenarios advantageously be an isotropic micro lens array.

In some embodiments, the arrangement may specifically be a stack of objects.

In some embodiments, the at least one optical elements and/or the microlens array may be substantially planar.

An element or optical layer may be considered planar if it is substantially flat. For example, an element or layer may be considered planar if a deviation from a two dimensional plane is less than 10% of the maximum extension of an active area in the two dimensional plane. The active area may be an area contributing to an active part of the generated pattern. The group of planar optical elements may comprise one or more optical elements.

The (planar) optical element may in some embodiments be curved to some extent. Specifically, a curved element may be considered planar if its thickness is e.g. maximum 5% of the radius of curvature.

The light projector may employ light radiation in the direction from the group of planar optical elements to the microlens array.

In accordance with an optional feature of the invention, the light projector comprises a light source located such that light from the light source propagates through the group of at least one optical elements to the micro lens array; and wherein the group of at least one optical elements comprises at least one light attenuating optical element having a light attenuating pattern corresponding to a light pattern of the plurality of light patterns.

This may provide a particularly efficient, low complexity, low cost and/or improved generation of optical patterns at different distances. In many embodiments, the approach may allow low cost light sources and optical elements to be used. Indeed, in some embodiments a low cost light source providing diffused light may be used with low complexity optical elements in the form of transparent substrates carrying opaque, or semitransparent, patterns, e.g. printed thereon.

The first group of optical elements may be positioned between the light source and the micro lens array.

In accordance with an optional feature of the invention, the group of at least one optical element comprises at least one light emitting element arranged to emit a spatial light pattern corresponding to at least one of the patterns of the plurality of light patterns.

This may in many embodiments provide increased performance, reduced power consumption, increased flexibility, or facilitated implementation. For example, it may obviate the need for a separate light source to be included. The at least one planar light emitting element may thus not just propagate light but may itself create the light forming the light pattern. Thus, the at least one planar light emitting element may be an actively light creating element with the created light corresponding to a pattern of the plurality of light patterns.

In accordance with an optional feature of the invention, the at least one planar light emitting element is an Organic Light Emitting Diode, OLED, array.

This may provide a particular advantageous implementation with accurate optical patterns being generated while keeping cost and power consumption to low levels. Furthermore, OLED may be particularly efficient when used in scenarios where the light projector in additional to the light patterns also radiates other light, such as e.g. diffused light at other frequencies than used for the light patterns.

In accordance with an optional feature of the invention, the group of at least one optical element comprises a plurality of patterned optical elements, each patterned optical element having a different fixed pattern corresponding to a pattern of the plurality of light patterns.

This may provide a particularly efficient, low complexity, low cost and/or improved generation of optical patterns at different distances. In many embodiments, the approach may allow low cost light sources and optical elements to be used. Indeed, in some embodiments a low cost light source providing diffused light may be used with low complexity optical elements in the form of transparent substrates carrying opaque, or semitransparent, patterns, e.g. printed thereon.

In accordance with an optional feature of the invention, the light projector is arranged to radiate at least some of the plurality of light patterns simultaneously.

This may in many embodiments allow a particularly efficient implementation and may reduce cost or complexity. The approach may furthermore allow e.g. vision detection systems to be able to assume that the patterns are always present. The approach may for example allow different patterns to be considered when analyzing in a single image even for fast shutter times.

In accordance with an optional feature of the invention, the light projector is arranged to radiate at least some of the plurality of light patterns time sequentially.

This may in many embodiments allow a particularly efficient implementation and may reduce cost or complexity and/or may provide improved performance. It may for example obviate the need for a plurality of patterned optical elements. The approach may further be particularly amenable to implementations wherein the light patterns are generated by dynamically controllable optical elements as this may often allow patterns to be flexibly generated.

In accordance with an optional feature of the invention, at least one optical element of the group of at least one optical elements is a programmable optical array of controllable elements capable of changing an optical characteristic in response to a control signal; and the light projector further comprises means for generating the control signal to provide at least one of the plurality of light patterns.

This may provide particularly advantageous operation and/or implementation in many embodiments. For example, it may allow patterns to be adapted to the specific characteristics. The optical characteristic may be at least one of a light emitting or light attenuating characteristic.

In accordance with an optional feature of the invention, the plurality of light patterns are infrared light patterns.

This may be particularly advantageous in many scenarios. The invention may for example provide invisible optical patterning that can be used by a vision system to derive characteristics without being distracting or inconvenient to users.

In accordance with an optional feature of the invention, the light projector further comprises a visual light source arranged to radiate visual light through the micro lens array.

The light projector may specifically provide visual light radiation with no patterning together with invisible optical light patterns. Thus, a single light projector may not only be used to e.g. light up an area but may also provide additional patterning that can be used to analyze the area. The visual light may specifically be incoherent, diffuse light. The visual light may in some embodiments further propagate through at least one of the group of optical layers.

In accordance with an optional feature of the invention, at least some of the plurality of light patterns are repetition patterns having different spatial repetition patterns relative to each other.

This may provide a highly advantageous use of the characteristics of the micro lens array to provide different focusing distances merely be changing spatial repetition distances for a repetition pattern. Specifically, the pattern may be formed by spatially repeating pattern segments with the relationship between the pitch of the microlens array and the pitch of the pattern segment repetition determining the focal distance. In some embodiments the pitch of the pattern segment repetition may advantageously be higher than the pitch between micro lenses of the micro lens array. In some embodiments the pitch of pattern segment repetition may advantageously be lower than the pitch between micro lenses of the microlens array.

In accordance with an optional feature of the invention, the light projector further comprises a projection lens situated opposite of the micro lens array from the group of at least one optical elements; and wherein a focal surface for each of the light patterns by the microlens array is on a side of a plane of the projection lens towards the microlens array.

This may improve the light emission in many embodiments. In particular, it may allow focusing of optical patterns at distances that are larger than typically achieved with micro lens arrays only. Thus, it may compliment the focusing by the microlens array by translating the microlens focus planes to focus planes at further distances.

In accordance with an optional feature of the invention, at least one of the light patterns is arranged to provide at least one of a non-planar focus surface and a focus surface not parallel to a plane of the micro-lens array.

The invention may provide very flexible focusing surfaces that may be adapted to the specific application and/or environment. The approach may improve performance and/or may allow further applications. For example, one or more of the optical patterns may be arranged to result in a focus plane which is tilted relative to the plane of the microlens array.

According to an aspect of the invention there is provided a vision detection system comprising: the light projector preciously described; a receiver for receiving an image from a camera; a pattern detector arranged to perform a pattern detection for patterns in the image corresponding to the plurality of light patterns; and a circuit for determining a characteristic of an object reflecting light from the light projector in response to the pattern detection.

The approach may allow a facilitated and/or improved determination of characteristics of an object based on projected optical patterns. The image may be a frame of a video sequence and the system may use a plurality of frames to determine the characteristic.

In accordance with an optional feature of the invention, the characteristic is at least one of: a presence of the object; a distance to the object; a position indication for the object; a size of the object; a movement of the object; and a shape estimate of the object.

The approach may allow a facilitated and/or improved determination of a number of characteristics of an object reflecting the light radiated from the light projector.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of an example of elements of a light projector in accordance with some embodiments of the invention;

FIG. 2 is an illustration of an example of light patterns for a light projector in accordance with some embodiments of the invention;

FIG. 3 is an illustration of an example of elements of a light projector in accordance with some embodiments of the invention;

FIG. 4 is an illustration of an example of light patterns for a light projector in accordance with some embodiments of the invention;

FIG. 5 is an exemplary illustration of the concept of focussing light with a microlens array;

FIG. 6 is an illustration of an example of light patterns for a light projector in accordance with some embodiments of the invention;

FIG. 7 is an illustration of an example of elements of a light projector in accordance with some embodiments of the invention;

FIG. 8 is an illustration of an example of elements of a light projector in accordance with some embodiments of the invention;

FIGS. 9 and 10 illustrates examples of a projection of light patterns from a light projector in accordance with some embodiments of the invention;

FIG. 11 is an illustration of an example of elements of a vision system in accordance with some embodiments of the invention;

FIG. 12 is an illustration of an example of a projection of light patterns from a light projector in accordance with some embodiments of the invention;

FIG. 13 is an illustration of an example of elements of a light projector in accordance with some embodiments of the invention;

FIG. 14 is an illustration of an example of elements of a light projector in accordance with some embodiments of the invention;

FIG. 15 is an illustration of an example of elements of a light projector in accordance with some embodiments of the invention;

FIG. 16 is an illustration of an example of elements of a light projector in accordance with some embodiments of the invention; and

FIG. 17 is an illustration of an example of elements of a light projector in accordance with some embodiments of the invention.

### DETAILED DESCRIPTION OF SOME EMBODIMENTS OF THE INVENTION

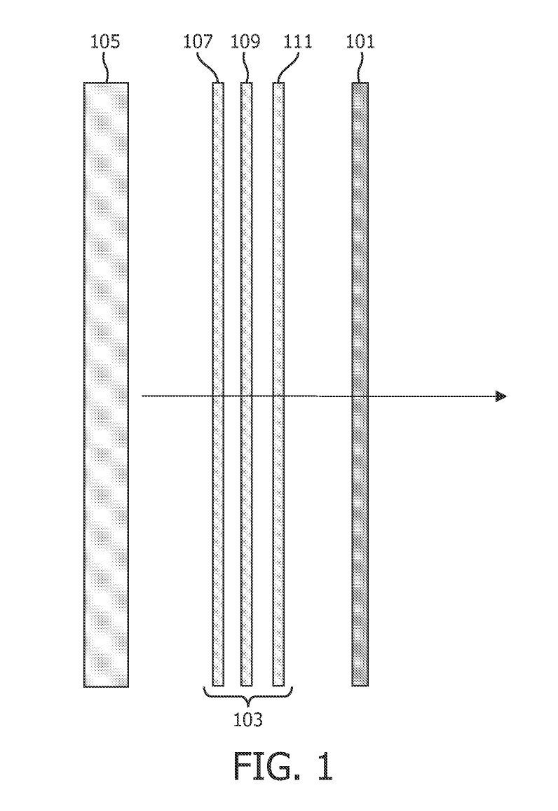

FIG. 1 illustrates an example of a light projector in accordance with some embodiments of the invention.

In the example, the light projector comprises an arrangement of elements which specifically is a stack of layered planar optical elements. However, it will be appreciated that in other embodiments e.g. curved elements may be used.

In the example, the stack comprises (in the direction opposite of the light emission), a micro lens array 101 and a group of planar optical elements for providing light patterns (henceforth also referred to as pattern elements or layers). The group of planar optical elements thus provides a plurality of light patterns to the microlens array 101 which provides a focussing effect on the light patterns such that these focus at different focal distances.

In the specific example, the light projector further comprises an internal light source 105 which in the example is a planar light source. The planar light source 105 may for example be generated as an array of light sources, such as LEDs or by a planer optical element spreading e.g. light fed in from an edge of the element across the surface of the element.

The internal light source 105 emits light which propagates through the group of planar optical elements 103 to the microlens array 101. In the example, the internal light source 105 generates an incoherent diffuse light. This may be advantageous in many embodiments, and may typically result in substantially reduced cost as diffuse light sources tend to be significantly lower cost compared to coherent light sources such as laser light sources. Furthermore, it may in many embodiments provide a more manageable and homogenous light. In particular, the sensitivity and likelihood of undesirable interference phenomena arising may be substantially reduced.

In the example, the group of optical elements 103 is shown to comprise three elements 107, 109, 111 which are light attenuating optical elements that have a light attenuating pattern upon them. The pattern elements 107, 109, 111 specifically have an opaque pattern on a transparent base. The contrast between the opaque and transparent areas may advantageously be no less than 10:1 and more advantageously no less than 100:1. Such an approach may in many scenarios be particularly advantageous as it may allow for low cost and easy implementation. For example, the pattern elements of the example of FIG. 1 may simply be generated as substrates of low-cost plastic on which opaque patterns have been printed by a laser printer.

In this way the group of optical elements creates a set of light patterns (equivalent to the different sub-patterns forming the combined pattern from the plurality of pattern elements 107-111).

The light patterns propagate to the microlens array 101 which perform a focusing effect such that the different light patterns are focused at different distances relative to the microlens array 101.

In the example of FIG. 1 the microlens array 101 is an isotropic microlens array where all lenses are substantially equal (e.g. all dimensions (length, width, height) may be within manufacturing tolerances. Typically, they may vary by less than 10%). Furthermore, the micro lenses may be arranged symmetrically in two planar directions, i.e. the pitch may be substantially identical in a horizontal and vertical direction. Such isotropic microlens arrays may not only provide improved optical characteristics in many embodiments but may also reduce cost as they are easier to manufacture. In the example, the micro-lenses may have a size of around 1 mm by 1 mm but it will be appreciated that this may vary for different embodiments. In most embodiments, micro lens pitches of between 0.3 mm to 5 mm tend to be advantageous.

In the example of FIG. 1, the multi-distance focussing is achieved by the interaction between the patterns and the micro lenses. Specifically, the effect of the microlens on the pattern is controlled to result in different focus distances. Thus, is achieved by designing the patterns such that the focussing effect of the micro lens array is different for the different patterns.

In the example, this is specifically achieved by the patterns being repetition patterns having a pattern segment spatially repeated. Specifically, the patterns are generated to provide an array of repeated pattern segments. The patterns use repetition pitches which are related to the pitch of the microlens array 101.

Indeed, it can be shown that for such a repeating pattern, the interaction between the different lenses of the micro lens array 101 interwork to provide a focus distance which depends on the pitch of the spatial repetition. Accordingly, in the example of FIG. 1, the different pattern elements 107-111 use different spatial repetition patterns. Specifically, they use different pitches for the repetition and further they use different repeated repetition segments.

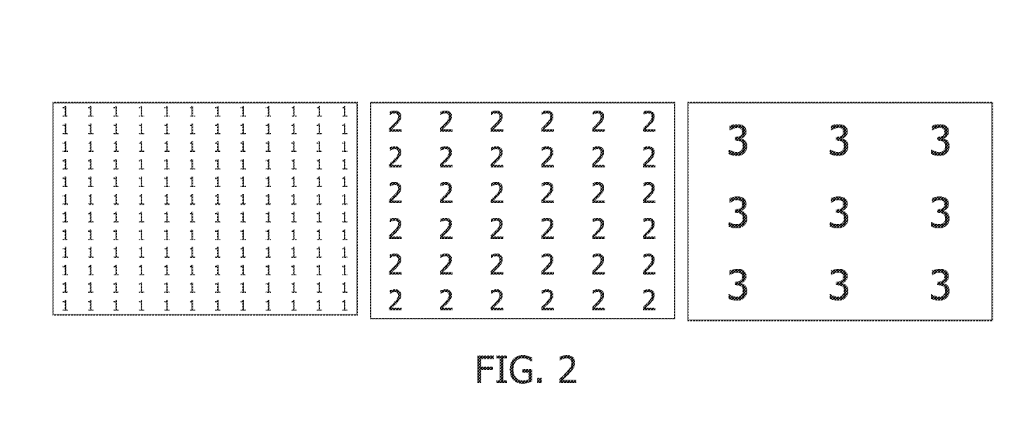

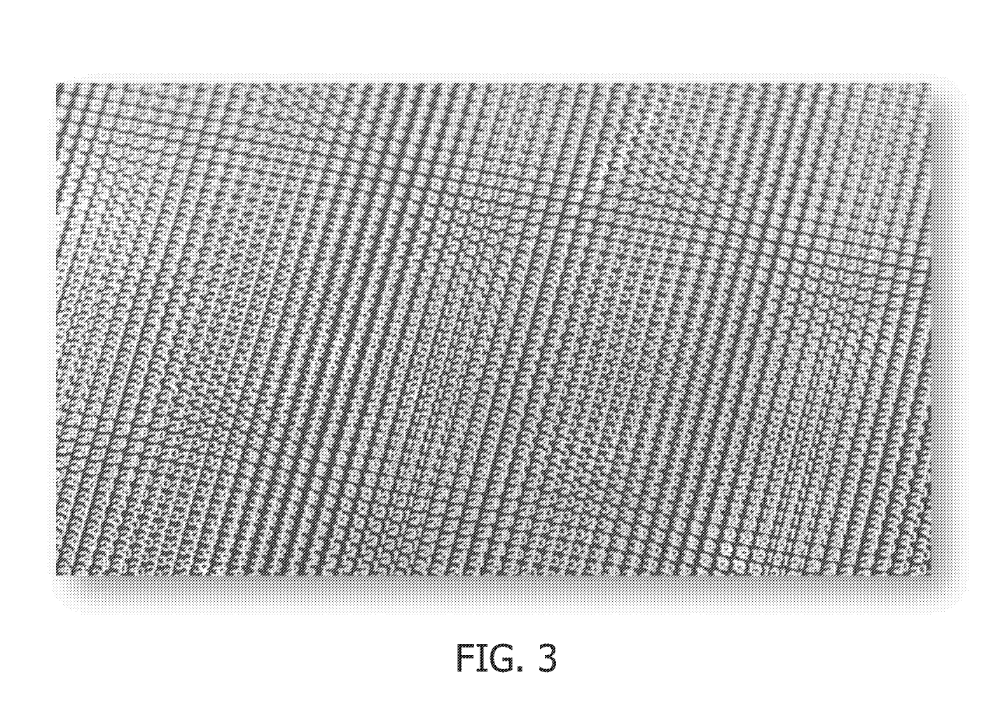

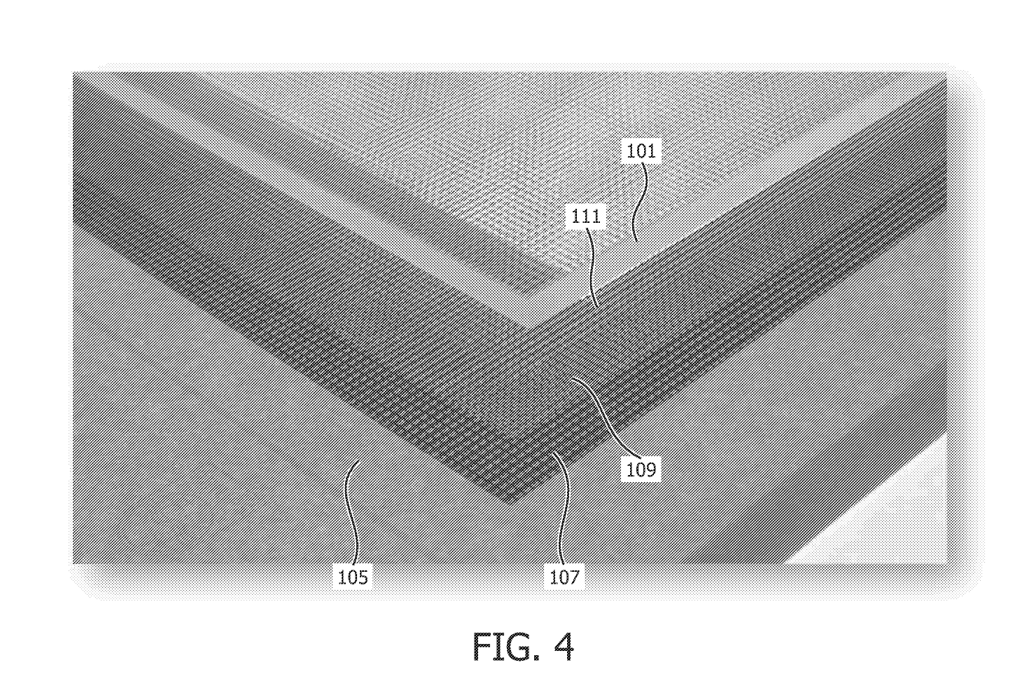

FIG. 2 shows an example of possible repetition patterns. In the example, the repeated segment is simply a number (1, 2 and 3 respectively) and the spatial repetition frequency is different. FIG. 3 illustrates how the combined composite pattern looks for such an example where the patterns have been printed on plastic elements that are placed on top of each other. FIG. 4 illustrates a picture of a practical stack of three pattern elements made from plastic with the described patterns printed on top together with a microlens array.

The spatial repetition pitch may specifically be in the same order of magnitude as the microlens array pitch. For example, the repetition pitch for one of the patterns may be, say, 10% higher than the microlens pitch, for another may be, say 20% higher than the microlens pitch, for another may be, say, 50% higher than the microlens pitch etc. Furthermore, the size of the repeated segment may also be increased for increasing repetition pitches. E.g. in the example of FIG. 2, the numbers with a higher repetition pitch are also themselves increased.

As a result of the different spatial repetition frequencies, the micro lens array 101 will cause the different patterns to be focussed at different distances. Thus, the focal planes are created by the use of micro lenses that have the same focal length and pattern elements providing masks that may be positioned in the focal plane of the micro lenses such that every lens is effectively projecting light rays at infinity or at least at the same image distance (being much larger than the focal distance). Subsequently, the multiple focal planes are formed by the integrated combination of light from the combination of lenses.

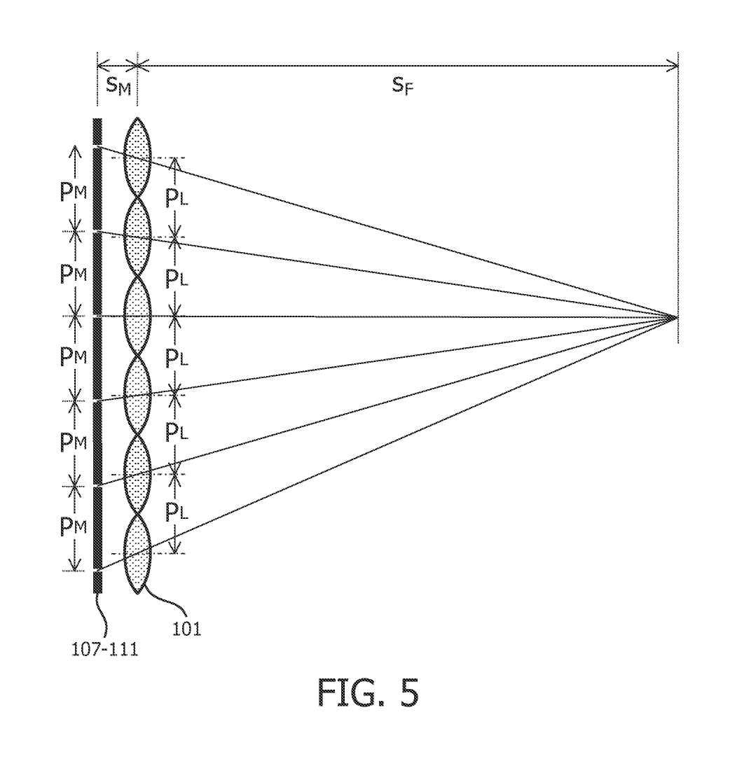

FIG. 5 illustrates the concept of focussing light with a microlens array. From left to right light is cast on a mask with holes at a regular distance p_{M}, which is referred to as the mask pitch. The light continues only from the holes to the microlens array. The lenses are equal and placed at a regular mutual distance p_{L}, which is referred to as the lens pitch. Depicted are the cardinal rays through the centre of each micro lens in paraxial approximation, neglecting the physical thickness of the microlenses. For proper convergence of the light rays, two geometrical conditions need to be met. A first condition regards the focus of each individual microlens, a second condition regards the integral focus of a collection of microlenses. To satisfy the first condition, each hole in the mask needs to be focused at the distance to the focussing point, s_{W}, which is obtained when

$$\frac{1}{{s}_{M}} + \frac{1}{{s}_{F}} = \frac{1}{{f}_{L}} , \qquad ( 1 )$$

where f_{L} is the focal length of each of the microlenses.

In practice, the focussing distance s_{F} tends to be large compared to the mask distance s_{M}, such that s_{F} can taken to be infinitely large compared to s_{M}. So, in practice, the mask distance is chosen equal to the focal length of the microlens array,

s_{M}=f_{L}. (2)

Integral con version of a collection of microlenses is determined by the mask pitch p_{M} in relation to the lens pitch p_{L}, which needs to satisfy

$${p}_{M} = \frac{{s}_{M} + {s}_{F}}{{s}_{F}} {p}_{L} . \qquad ( 3 )$$

When the mask is placed at the focal distance of the microlenses in the array we can combine the expressions and to obtain the following practical expression,

$${p}_{M} = \frac{{f}_{L} + {s}_{F}}{{s}_{F}} {p}_{L} . \qquad ( 4 )$$

The mask pitch p_{M} needs to be chosen greater than the lens pitch p_{L} to obtain a pattern that is focused in front of the microlens array, which is associated with a positive value of s_{F}. Alternatively, a negative value of sF is associated with a pattern focused at a virtual plane behind the mask; a situation achieved when p_{M} is chosen smaller than the lens pitch p_{L}.

In the specific example, the light patterns were generated using, a plurality of pattern elements 107-111 which each had a pattern that blocked light. It will be appreciated that in other embodiments, it may be the transparent sections that are combined to generate the desired composite pattern corresponding to the plurality of light patterns.

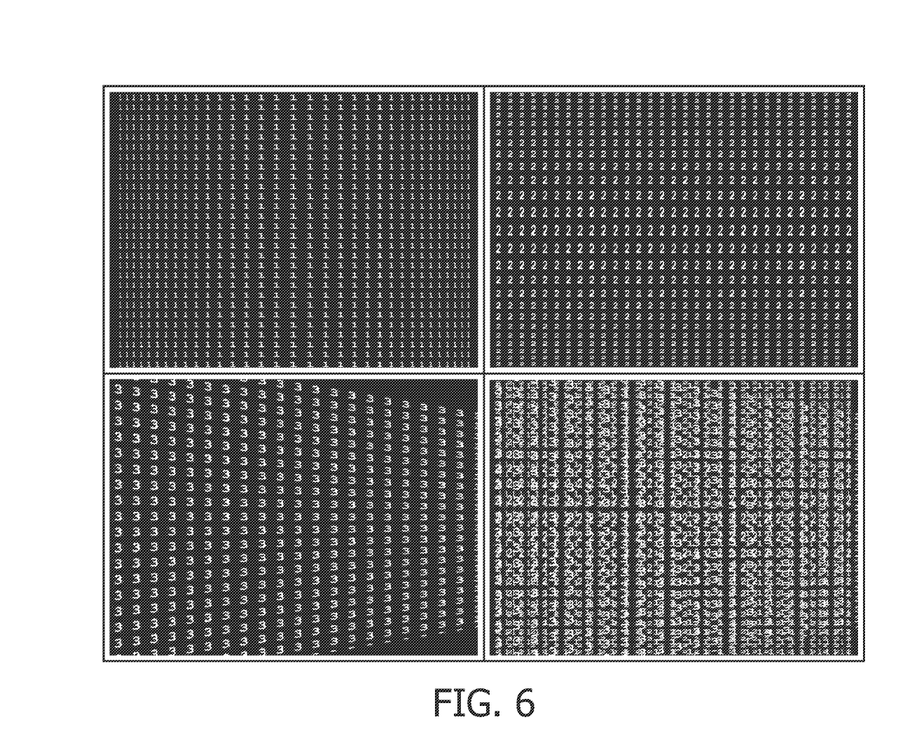

For example, FIG. 6 illustrates an example where spatially repeated symbols in the form of “1”, “2” or “3” leaves a transparent hole within an otherwise opaque mask.

Furthermore, in the example of FIG. 1, the composite pattern is generated by the opaque patterns are combined resulting in an even more opaque pattern. However, in other embodiments, the composite pattern may be generated by summing transparent patterns, such as e.g. in the combined pattern example of FIG. 6.

For example, referring to transparent (or “white”) as “1” and to the (black) mask as “0” a physical stacking of individual patterns may lead to a mask which quickly becomes very opaque blocking most of the light. The physical stacking can be seen as a logical AND operation of the local individual bits L(x,y) of the mask at each position (x,y), i.e. the composite pattern may is given as:

Lₜₒₜ(x,y)=L₁(x,y)&L₂(x,y)&L₃(x,y), (5)

with “&” being the logical AND operator.

Instead of such a physical stacking, a composite pattern may be generated using a logical OR operation, i.e. as:

Lₜₒₜ(x,y)=L₁(x,y)|L₂(x,y)|L₃(x,y), (6)

with “|” the logical OR operation.

Such an approach is used in the example of FIG. 6.

This has the consequence that the “2's” leave the space for the “1's” open and the “3's” leave everything transparent that is required for the other patterns. Of course, a combination of more and more patterns causes the opaque mask to finally disappear, so the number of patterns may in many embodiments be limited to a reasonable number.

It will be appreciated that in other embodiments other operations and specifically other (logical) operators may be used. For example the median of the pattern bits may be used to generate the composite pattern.

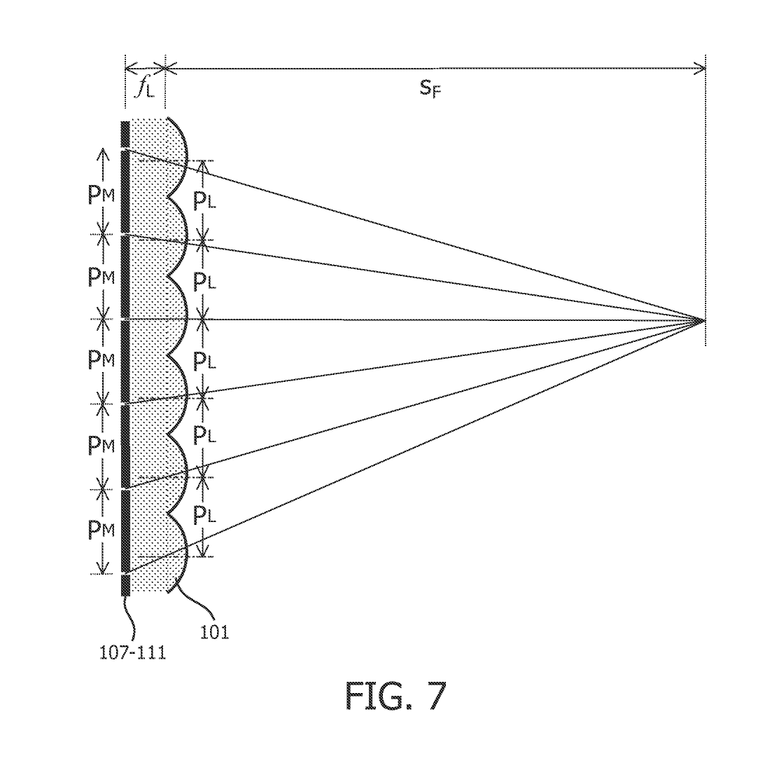

Thus, clearly rather than using a sequence of different optical elements each providing one pattern, a single element may be used which directly provides the composite pattern comprising the individual patterns. Indeed, such an element may even be integrated with the microlens array itself. For example, the composite pattern may directly be printed on the microlens array 101 as e.g. illustrated by the example of FIG. 7. In particular FIG. 7 illustrates an example of a specific geometric arrangement of mask and microlens array with a thickness equal to the focal length of the micro lenses allowing a patterned mask to be printed on, or attached to, the flat side of the microlens array.

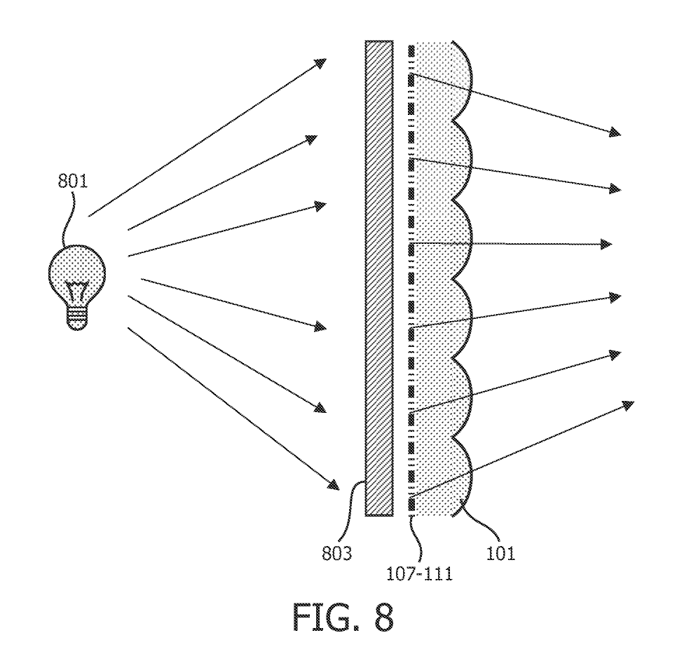

Another example is provided in FIG. 8 which further illustrates the light source 105 as comprising a single point light source 801 with an additional optical element 803 which for example may be a diffusing element, a collimating element (typ. Fresnel lens) being part of a collimating lens configuration, a polarizing element or an active (secondary) illuminating element.

The pattern can thus advantageously be e.g. printed onto the back of the microlenses array 101. In combination with a light source, the pattern mask is in many embodiments preferably reflective instead of opaque, so that the mask will reflect the blocked light back towards the light source. Since the light is recycled, this improves the brightness of the projection.

Additionally the mask can be produced in other ways than transparent/opaque: Several patterns can be encoded in separate colors/wavelengths and/or polarization. A (projection of a) mask built from segments of a polarizing film (e.g. horizontal=‘1’ and vertical=‘2’) is visually uniform, but can be analyzed with a camera equipped with a polarizing filter.

It will be appreciated that there are various options for combining multiple patterns focused at different distances. For instance the patterns could occupy different areas of the mask. An example would be to confine the patterns causing the farthest focus to be in the perimeter of the mask and patterns focused nearer to be in the centre. The different patterns could be printed in non-overlapping concentric ring-shaped areas (a “bullets eye”). The same concentric segmentation could also be partly overlapping to ensure that enough light goes through etc.

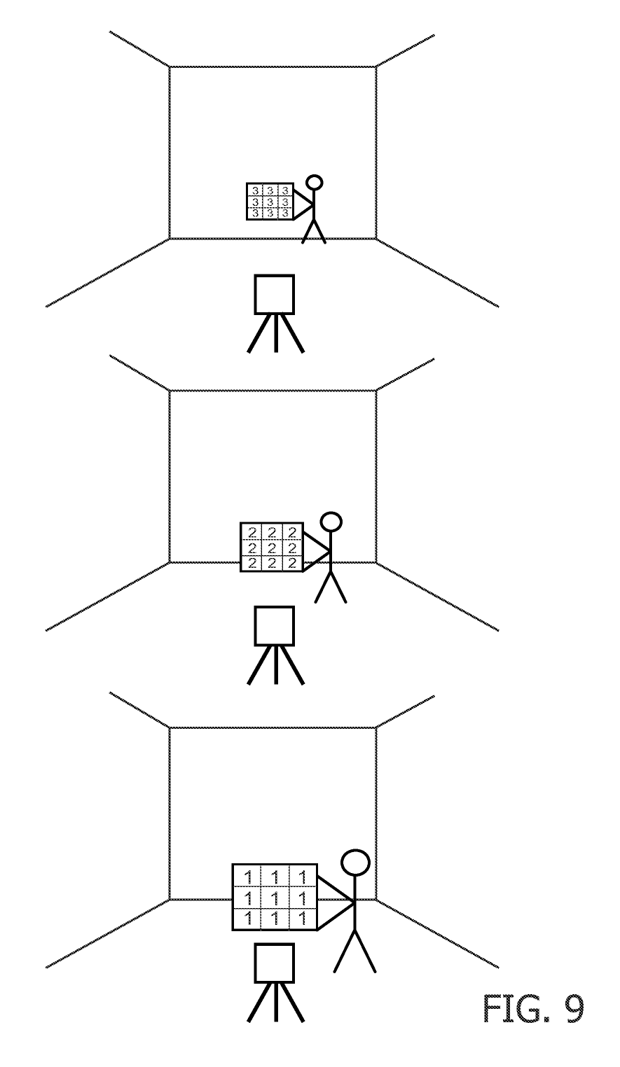

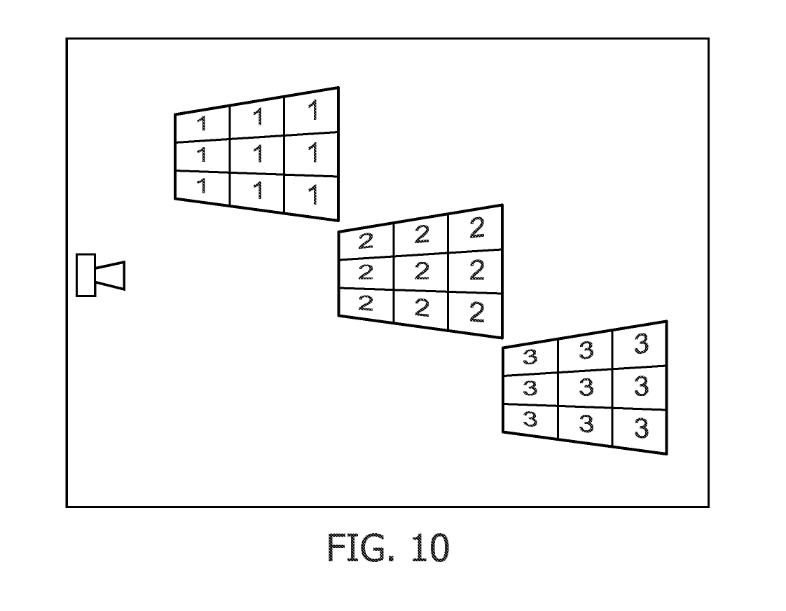

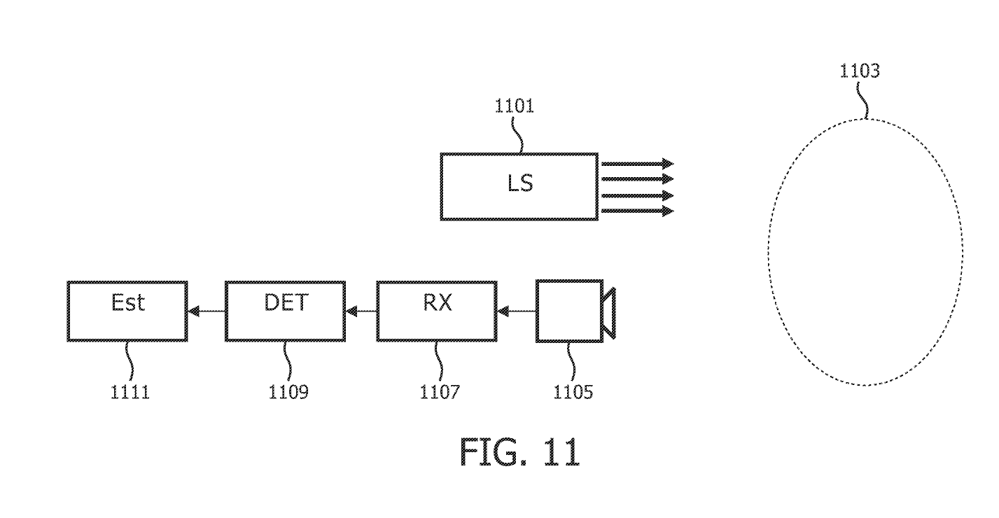

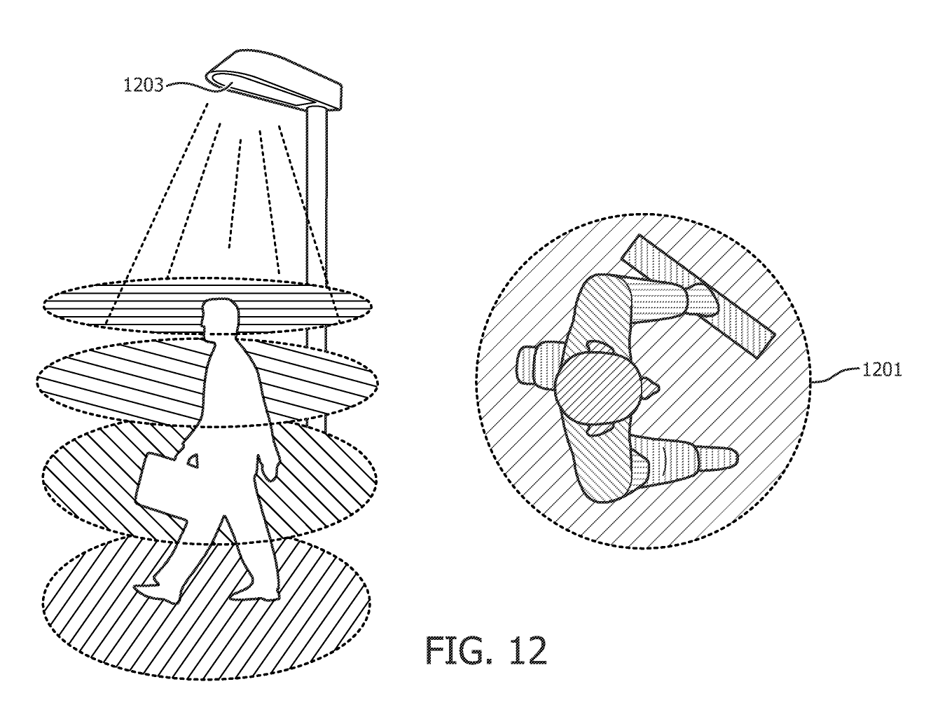

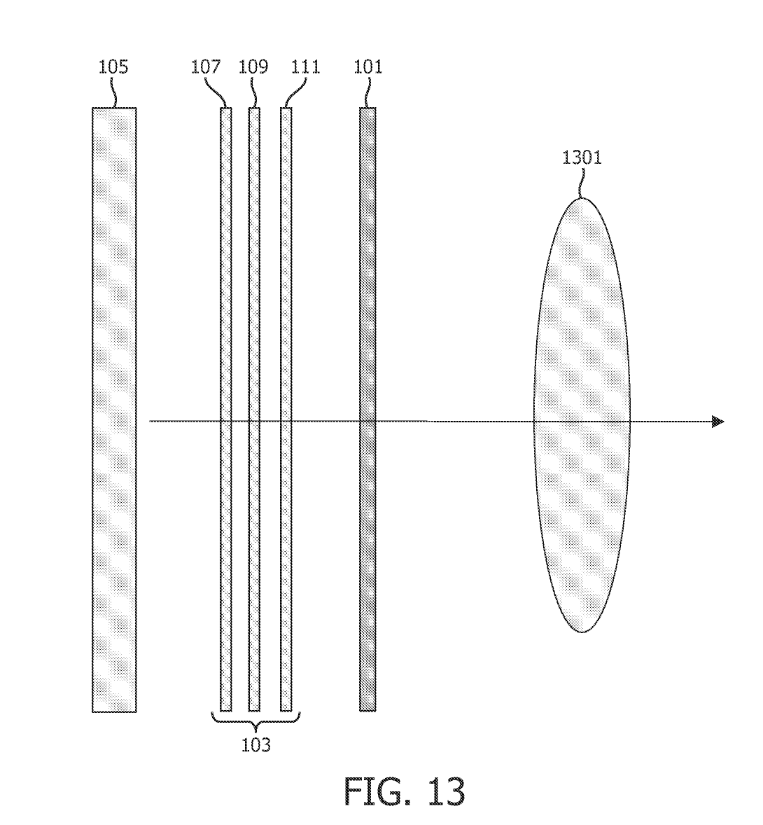

Thus, the light projector of FIG. 1 generates a light output which comprises a plurality of light patterns that are focussed on different distances. In the example, the plurality of light patterns are generated simultaneously and thus will be reflected simultaneously by objects. The effect will cause a pattern to emerge on objects that are close to the focal distance for the pattern. For example, the reflections on an object close to the focal distance for a first light pattern will result in that pattern being clearly projected on that object, an object close to the focal distance for a second light pattern will have that pattern clearly projected on it, etc. Thus, the projection of multiple patterns at multiple focal distances allows different patterns to emerge depending on distance. An example of such a scenario is shown in FIGS. 9 and 10.

The specific approach allows such patterns to be generated by a planar arrangement. Indeed, the approach provides a practical way of (simultaneously) creating multiple projected patterns, each of which is focused at a different distance. The specific usage of planar optical elements and a microlens array allows for a highly practical and advantageous implementation. Indeed, the light projector may be implemented using e.g. a stack of plastic optical elements, each of which is easy to produce. Further, easier implementation is typically possible when using planar optical elements as this facilities e.g. mounting, stacking etc. As a specific example, the layers of FIG. 1 may simply be positioned on top of each other. Indeed, an experimental setup has been created by simply laying suitable flat optical elements on top of each other with the stack simply being put on top of a standard overhead projector being used for the light source 105. Also, the characteristics of a light output from a planar arrangement may be highly advantageous in many scenarios. For example, the light projector may perform more as a distributed light projector and may provide a light output over a large surface rather than appearing as a single point light projector. Also, a planar stack approach may allow for advantageous form factors for the light projector in many embodiments.

The multi focal radiated patterns may be used to detect characteristics of objects that reflect light from the light projector. FIG. 6 illustrates an example of a vision system that comprises a light projector 1101 such as that described with reference to FIG. 1. The light projector 1101 radiates light which comprises the plurality of patterns that are focused at different distances. The light may be radiated into a detection area 1103 in which one or more objects may be located that may reflect the light from the light projector 1101. Thus, objects that are located in the detection area 1103 at distances that are close to the focal distances of the light projector 1101 will reflect the corresponding pattern. In the example, the vision system comprises functionality for determining one or more characteristics of one or more objects based on detection of the radiated patterns.

Specifically, the vision system comprises a camera 1105 which covers the detection area 1103. For clarity and brevity, the function will be described with reference to a single captured image and thus the camera 1105 may be a single shot/image camera. However, it will be appreciated that the camera may be a video camera and that the detection may be based on a sequence of images. In particular, the following description may be considered to refer to one image out of a sequence of images, and specifically to one frame of a video sequence.

The camera is coupled to a receiver 1107 which interfaces the detection functionality to the camera 1105. The receiver receives the image signal from the camera and feeds the corresponding image to a detection processor 1109 coupled to the receiver 1107.

The detection processor 1109 is arranged to perform a pattern detection for patterns in the image corresponding to the light patterns of the light projector 1101. Specifically, the detector may evaluate the entire image with respect to each of the possible radiated patterns to see if any match occurs. The detection processor 1109 may specifically segment the image into areas where each segment corresponds to either one of the radiated patterns that is considered dominant in the segment or to there being no dominant pattern present in the segment (e.g. if there are no objects at any of the focus distances).

It will be appreciated that any suitable pattern detection algorithm may be used and that the skilled person will be aware of a range of possible pattern detection algorithms. The detection processor 1109 is coupled to an estimation processor 1111 which is arrange to determine a characteristic of an object reflecting light from the light projector in response to the pattern detection performed by the detection processor 1109. The estimation processor 1111 may specifically determine the characteristic based on the segmentation performed by the detection processor 1109.

For example, the approach may be used to detect whether an object is present in the detection area 103. For example, the light projector 1101 may be arranged to radiate the light into a room with no objects. The distance to a rear wall may be longer than any focal distances for the emitted patterns. Thus, when no objects are present in the room, the light will hit the rear wall as an unfocused light thereby not presenting any dominant or clear pattern. The camera will record an image of the room which accordingly does not contain any dominant patterns. The detection processor 1109 will accordingly segment the whole image into a segment (or a plurality of segments) corresponding to no significant pattern. The estimation processor 1111 will evaluate the segmentation and decide that no object is present as none of the patterns are detected.

However, if an object, such as a person, enters the room at a distance to the light projector which sufficiently closely corresponds to one of the focal distances, the object will reflect a clearer and possibly well focussed pattern. The detection processor 1109 will accordingly segment the captured image into at least one segment that corresponds to this pattern. In response the estimation processor 1111 will proceed to determine that an object has entered the detection area 1103 due to the presence of the segment(s) with a dominant pattern.

The system may determine more specific characteristics based on the pattern detection. For example, a distance to the object may be estimated based on the pattern recognition. As a low complexity example, a segmentation of the image may be into segments corresponding to each of the patterns, and the object corresponding to a segment may be considered to be at a distance corresponding to the focal distance of the corresponding pattern. In more complex embodiments, the system may be able to detect that an object reflects more than one of the patterns. For example, if an object is in-between two focal distances that are relatively close to each other, the object may reflect both patterns albeit with some blurring. This may be detected by the vision system which may determine the distance to be between the two focus distances. In some embodiments, the relative blurring between the patterns may be assessed to estimate the exact distance within the interval between the two focal distances.

As another example, the vision system may be arranged to estimate a size of the object. For example, based on the pattern, the distance to the object may first be detected. The segmentation may then be used to determine a size of the object in the image. Specifically, the segmentation may be evaluated to generate an image object corresponding to the detected object. A low complexity embodiment may for example simply combine close segments associated with the same pattern. Based on the size of the object in the image and the estimated distance, the size of the object may then be calculated.

As yet another example, the vision system may be arranged to estimate a shape of an object. For example, the shape may be considered to correspond to the shape of a segment corresponding to the appropriate pattern,

As a specific example, FIG. 7 shows how the approach may be used to detect characteristics, such as a height, of an object (in the specific example the test object is a figure of a Smurf). In the example, the light projector is placed above the test object and creates patterns focussed at different heights above a base level. The test object will reflect the pattern corresponding to the relative height of the first surface in the vertical direction resulting in an image with a combined pattern 1201.

In the specific example, the light projector's projection of specific patterns is combined with a light illuminator that provides illumination of an area. Specifically, the system is implemented in a street light 1203 which illuminates an area. The street light generates the light patterns e.g. as infrared light patterns close to the ground.

The vision system may then process the image to detect the patterns and e.g. may determine the height of the object as the detected pattern which corresponds to the highest focal plane.

In many scenarios, an advantage of the described approach is that motion parallel to the focal planes does not result in motion blur. Rather, in many scenarios such motion may indeed be advantageous in providing larger areas of the reflected patterns in the image. For example, if a long exposure time is used, a moving object will reflect the pattern along its path and will accordingly produce an extended area of the desired pattern. If the size of the object is known (or e.g. estimated for a previous image where the object was stationary), the extent of the pattern may be used to estimate e.g. a speed of the moving object.

As another example, the system may be used to estimate motion components that are in directions perpendicular to the focal planes. For example, if the camera 1105 records a video sequence wherein the reflected patterns gradually change from those corresponding to longer focal distances to those corresponding to shorter focal distances, the vision system may estimate that the object is moving towards the camera. Furthermore, any sideways movement between frames may be estimated based on image movements of segments corresponding to the same pattern.

Thus, in combination with e.g. computer vision, the use of multifocal projection may create various new options for detection and localization of static and moving objects. The multi-focal light projection may e.g. be used for any form of detection in which proximity plays a differentiating role. Indeed, even in combination with low-cost computer vision, the approach allows robust identification of objects at a specific distance from the light projector.

The approach may provide particularly advantageous performance in many low-light scenarios. Indeed, only low complexity pattern detection is necessary and this may often allow acceptable operation even in very low light environments. Furthermore, motion blur (resulting e.g. due to long shutter times) will for movement in the directions of the focal planes (i.e. typically sideways in the surveyed area/image) tend to merely result in easy-to-detect pattern. In the presence of such motion, detection remains robust as the pattern itself does not move. In fact, experiments have shown that the motion blur instead tends to increase the extent of the pattern. Consequently, the method may be particularly suitable even in very challenging light conditions using relatively long shutter times.

In the previous example, the microlens array 101 (together with the pattern characteristics) directly focuses the patterns at the desired focal distances. This may be suitable for many practical applications and in particular for implementations wherein relatively low focus distances are needed.

However, in some embodiments it may be advantageous to further include a projection lens to focus the light from the microlens array 101. This may e.g. often be advantageous when higher focal distances are required.

FIG. 8 illustrates an example of the light projector of FIG. 1 with an additional projection lens 1301. The projection lens is positioned opposite of the microlens array from the group of planar optical elements. Thus, the light patterns from the pattern elements 107-109 first reach the microlens array 101 and the light from the microlens array 101, and then propagate to the projector lens 1301 from which the light exits the light projector.

The microlens array 101 generates focal planes which are internal in the light projector. Specifically, the focal surfaces from the microlens array 101 fall on the side of the plane of the projection lens which is towards the microlens array. In the example, the microlens array 101 thus creates focal planes that are not on the other side of the projection lens 1301 but rather are on the same side as the microlens array 101. As a consequence, the projection lens 1301 will create external focus planes corresponding to the internal focal planes.

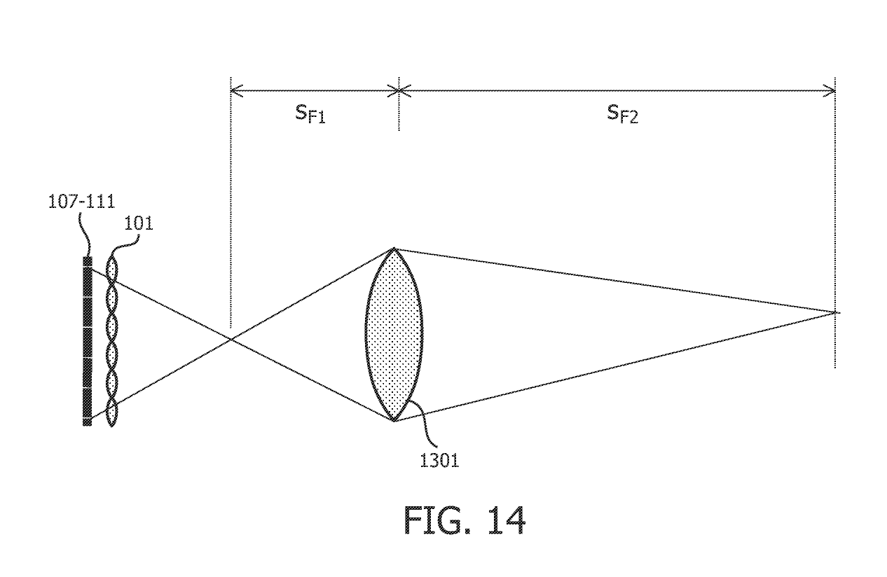

The relation between virtual the focus planes in front of and behind the projection lens is given by

$$\frac{1}{{s}_{F 1}} + \frac{1}{{s}_{F 2}} = \frac{1}{{f}_{P}} , \qquad ( 7 )$$

where s_{F1} is the focus distance of a pattern created by a microlens array and a mask, and s_{F2} is the focus distance of this pattern as it is projected by the projection lens with focal length f_{P}. The geometrical configuration is depicted in FIG. 14.

In some embodiments, the focal surfaces created by the micro lens array 101 may specifically be behind the microlens array 101 itself. Thus, the microlens array 101 may create focus planes that are lower in the stack than the micro lens array 101 itself. This may result in improved performance in many scenarios and may specifically result in external focal planes at further distances.

As an example, the described approach may e.g. allow external focal distances of e.g. 1 meter, 2 meters, 4 meters, and 8 meters to be created by a light projector with dimensions of less than 20 cm.

Indeed, in some embodiments, the projection lens 1301 may be a substantially planar lens which can be integrated in the stack resulting in a flat design that is highly compact. In particular, the projection lens may be implemented as a Fresnel lens.

In the previous examples, the light patterns were created by a single light projector providing a diffuse light combined with a number of passive optical elements attenuating the light to provide the patterns.

However, in other embodiments, the patterns may directly be generated by active optical elements that emit the spatial light patterns. Thus, the light patterns may not be generated by attenuating light but may rather be generated directly as light having a spatial pattern.

An example of such an embodiment is illustrated in FIG. 9. The example corresponds to the light projector of FIG. 1 except that the light source 105 has been removed and the group of layers 103 comprises three active elements that themselves generate light in a suitable pattern. Such an approach may be advantageous in many embodiments as it may obviate the need for the light source 105 and may in many scenarios provide improved performance.

A particularly advantageous approach is to use Organic Light Emitting Diode (OLED) arrays for one or more of the planar light emitting elements.

Thus, in some embodiments an active OLED element may be used instead of a passive mask together with a diffuse light source. An OLED element can easily be printed with any pattern such that light is efficiently generated at only the locations dictated by the desired pattern. Furthermore, OLED elements typically use a glass substrate and therefore are generally transparent. This makes them very suitable for a stack arrangement as they will inherently allow light from lower layers to pass through. OLEDs may specifically provide an unobstructed path for e.g. visible light. Furthermore, OLED generates incoherent light which may be highly advantageous as it provides a more robust system with less sensitivity to undesired interference phenomena.

In some embodiments, the light projector may generate patterns of visual light at different focus distances. This may be advantageous in many scenarios and may e.g. allow standard vision cameras to be used thereby providing a low cost system. As another example, it may be useful for applications where the presence of patterns is directly detected by users without any automated detection functionality.

However, in many embodiments, InfraRed (IR) light may advantageously be used. Thus, in many embodiments, the light patterns are infrared light patterns. This may be advantageous in many embodiments as invisible patterns may be generated at different focal distances which however can easily be detected by a vision system. Thus, the user of IR patterns may be combined with an IR vision system that detects the IR patterns. In such embodiments, the vision system may effectively limit the bandwidth to that corresponding to the generated patterns. E.g. it may filter out visible light. Another advantage is that the IR pattern may be very clear on objects that do not necessarily reflect visible light that well, such as e.g. dark or black objects.

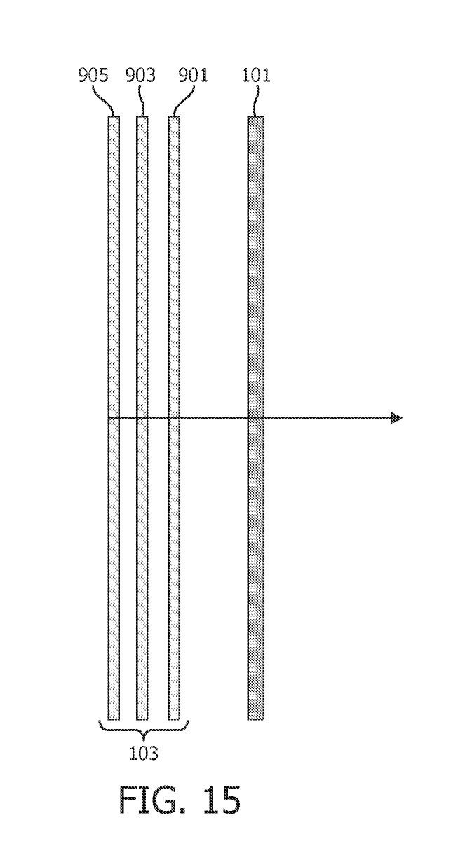

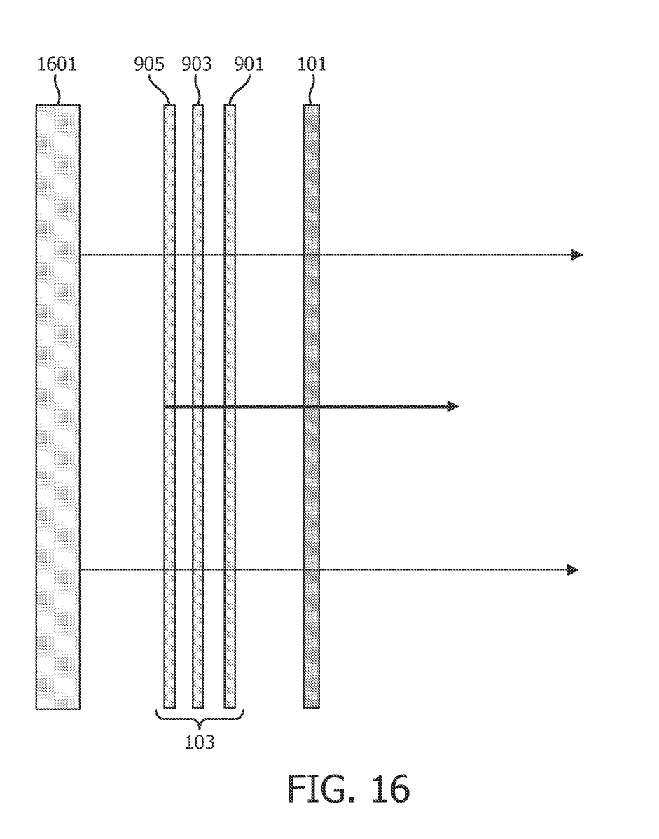

In some embodiments, the use of IR patterns may be combined with emission of visual light. For example, as illustrated in FIG. 16, the light projector of FIG. 15 may additionally comprise a visual light source 1601 which is arranged to radiate visual light through the micro lens array 101.

The visual light source 1601 may specifically generate visible, diffuse, incoherent light that propagates substantially unaffected through the group of pattern elements 103. Furthermore, for such visible, diffuse, incoherent light, the microlens array 101 may not have any significant optical effect and thus the visible light is radiated from the light projector. Thus, a very compact and easy to manufacture light projector is created which simultaneously emits visible light and invisible IR light patterns at different focal distances.

In other embodiments, the group of elements 103 may use passive masks that only block infrared light while allowing visible light to pass through. In such an embodiment, the system may comprise both a visible and IR light source, or indeed a single light source 1601 may be able to provide light over both an IR and visible frequency range. Thus, such a system may allow the visual light to pass through the entire stack including the micro lens array 101 while maintaining its untextured uniform nature. Only the infrared part will be textured and focused at various distances.

Thus, in the example the projection of infrared light patterns and visual light illumination can be combined into an integrated system, where the projection system benefits from the reflective elements of the illumination system. This approach may be used together with a vision and detection system which is sensitive only to IR light. The detected characteristics of objects may further be used to control e.g. the visible light illumination.

As a specific example, the approach may be used for street illumination where e.g. the visible street illumination may be adapted based on the height of any objects detected using the IR patterns.

In some embodiments one or more fixed pattern elements may be composed of an optical element of which the light attenuation can be controlled between opaque and transparent. For example, such a controllable optical element can be electrophoretic element or “electronic ink” element with a spatially fixed pattern of which the opacity can be varied by a single voltage over the two electrodes of the element. In such a case, the pattern elements 107-111 of FIG. 1 may e.g. be replaced by controllable electrophoretic elements for which the opacity of the individual patterns can be controlled to provide the desired patterns.

In the previous examples, fixed pattern elements where used to generate the light patterns. However, in some embodiments one or more of the optical elements of the group of planar optical elements is a programmable optical array which comprises controllable elements capable of changing an optical characteristic in response to a control signal.

The programmable optical array may specifically be an array corresponding to those used to provide the image in various display technologies. For example, the programmable array may be a Liquid Crystal Display (LCD) array comprising pixel elements that can change their transparency in response to an electrical signal. In such a case, the pattern elements 107-111 of FIG. 1 may e.g. be replaced by programmable LCD arrays for which the individual pixels can be controlled to provide the desired patterns.

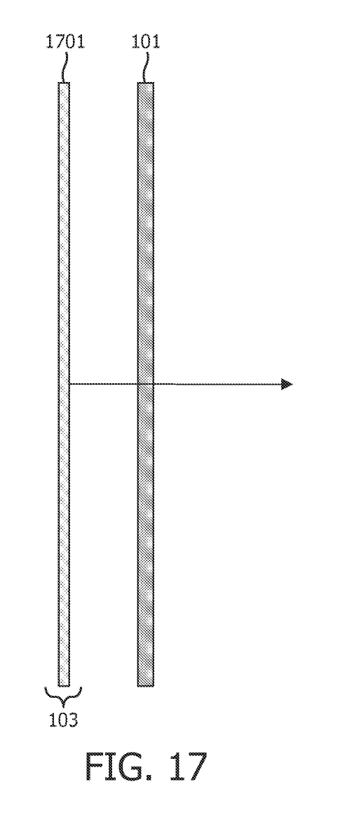

In some embodiments the programmable array may directly generate the light rather than merely modulate incident light. For example, as illustrated in FIG. 17, the light projector may simply comprise a single programmable light radiating element 1701 which provides the light patterns. In some cases, the single programmable light radiating element 1701 may generate the plurality of light patterns by directly generating the combined or composite pattern that originates by light passing through the sequence of pattern elements of e.g. FIG. 1.

The active programmable light generating array may specifically be a programmable OLED element.

A significant advantage of using programmable arrays is that it may allow the patterns to be modified dynamically. This may for example be used to adapt and modify the patterns to result in different focal distances. For example, the system may first use one set of patterns corresponding to a distance between neighbor focal planes of, say, 1 meter. This may result in coverage of a large area. If an object is detected, the patterns may be changed to result in much closer focal plane distances. E.g. the patterns may be changed to reduce the distance between neighbor focal planes to e.g. 25 cm. This may result in coverage of a more restricted area which however may be targeted around the specific distance estimated for the object. Thus, the programmable arrays may be used to refine an initial rough distance estimation to provide a finer and more accurate estimation.

Furthermore, whereas the previous description has focused on embodiments wherein the light patterns are projected continuously and simultaneously, at least some of the patterns may in other embodiments be projected time sequentially. This may for example be achieved using a programmable array.

For example, the light projector of FIG. 17 may in a first time slot radiate a first light pattern at a first focal distance by the programmable light radiating element 1701 being controlled to provide the corresponding pattern. The time slot is then followed by another time slot wherein the programmable light radiating element 1701 is set to a different pattern corresponding to a different distance, etc.

The detection may e.g. be modified by considering a plurality of images to see if a pattern emerges in any image. As a specific example, each time slot may correspond to a frame of a video sequence thereby facilitating detection. However, in other scenarios the time slots may have such short duration that a plurality, and possibly all, of the patterns may be projected during the exposure time of a single image. In this case, the time sequential nature of the projected patterns need not impact on the detection as the image will reflect any pattern that has been reflected in any of the time slots.

An advantage of such sequential pattern projection is that it may be more practical to implement, e.g. it may provide a simpler implementation. Furthermore, it may allow the patterns to be kept separate of each other. Indeed, the approach may allow that only a single pattern is projected at a time, and thus that there is no composite or combination of the different patterns. This may in many embodiments allow an improved focusing and performance of the system as a whole.

The previous description has focussed on the generation of focussing planes for the patterns which are parallel to the planar dimensions of the optical elements in the stack.

However, in some embodiments one or more of the light patterns is arranged to provide a non-planar focus surface or (and) a focus plane which is not parallel to a plane of the micro-lens array.

For example, the patterns may be generated to be tilted relative to the planes of the optical elements, i.e. the planar patterns may be tilted without tilting the mask. This can be achieved by gradually varying the spatial repetition rate over the pattern.

Such an approach may be advantageous in many scenarios. For example, it may be used to calibrate an angle to a wall. For example, the light projector may be setup to generate a pattern with the desired tilt (e.g. using a programmable array together with pre-calibrated patterns for different angles). The light projector may then be directed towards the wall at an appropriate distance and rotated until the entire pattern is clear on the wall. The angle of the light projector relative to the wall then corresponds to the angle set for the pattern.

Indeed, by varying the pattern, it is possible to create virtually any desired three-dimensional focal pattern in front of the light projector. For example, a non-planar focus plane may be generated by patterns as indicated in FIG. 6. An advantage of using such a non-planar focal plane may be to allow the detection of an object as it crosses a non-planar perimeter in 3D space. Another application is the verification of the (non-planar) shape of an object, e.g. as part of a production process.

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. A light projector comprising an arrangement of layered optical elements, the stack comprising:
a group of at least one optical element arranged to provide a plurality of light patterns; and
a microlens array to focus the plurality of light patterns at different focal distances.

2. The light projector of claim 1 wherein the light projector comprises a light source located such that light from the light source propagates through the group of at least one optical element to the microlens array; and wherein the group of at least one optical elements comprises at least one light attenuating optical element having a light attenuating pattern corresponding to a light pattern of the plurality of light patterns.

3. The light projector of claim 1 wherein the group of at least one optical element comprises at least one light emitting element arranged to emit a spatial light pattern corresponding to at least one of the patterns of the plurality of light patterns.

4. The light projector of claim 3 wherein the at least one planar light emitting element is an Organic Light Emitting Diode, OLED, array.

5. The light projector of claim 2 wherein the group of at least one optical element comprises a plurality of patterned optical elements, each patterned optical element having a different fixed pattern corresponding to a pattern of the plurality of light patterns.

6. The light projector of claim 1 wherein the light projector is arranged to radiate at least some of the plurality of light patterns simultaneously.

7. The light projector of claim 1 wherein the light projector is arranged to radiate at least some of the plurality of light patterns time sequentially.

8. The light projector of claim 1 wherein at least one optical element of the group of at least one optical element is a programmable optical array of controllable elements capable of changing an optical characteristic in response to a control signal; and the light projector further comprises means for generating the control signal to provide at least one of the plurality of light patterns.

9. The light projector of claim 1 wherein the plurality of light patterns are infrared light patterns.

10. The light projector of claim 9 further comprising a visual light source arranged to radiate visual light through the microlens array.

11. The light projector of claim wherein at least some of the plurality of light patterns are repetition patterns having different spatial repetition patterns relative to each other.

12. The light projector of claim 1 further comprising a projection lens situated opposite of the microlens array from the group of at least one optical element; and wherein a focal surface for each of the light patterns by the microlens array is on a side of a plane of the projection lens towards the microlens array.

13. The light projector of claim 1 wherein at least one of the light patterns is arranged to provide at least one of a non-planar focus surface and a focus surface not parallel to a plane of the micro-lens array.

14. A vision detection system comprising:
the light projector of claim 1;
a receiver for receiving an image from a camera;
a pattern detector arranged to perform a pattern detection for patterns in the image corresponding to the plurality of light patterns; and
a circuit for determining a characteristic of an object reflecting light from the light projector in response to the pattern detection.

15. The vision system of claim 14 wherein the characteristic is at least one of:
a presence of the object;
a distance to the object;
a position indication for the object;
a size of the object;
a movement of the object; and
a shape estimate of the object.
